(19) United States
(12) Patent Application Publication
(10) Pub. No.: US 2026/0297979 A1
(43) Pub. Date: Oct. 1, 2026

(54) MECHANICALLY KEYED LOCKS WITH ISOLATED VALIDATION

(71) Applicant: Level 6 Innovations LLC, Prior Lake, MN (US)

(72) Inventor: Todd D. Brooks, Prior Lake, MN (US)

(21) Appl. No.: 19/477,411

(22) PCT Filed: Apr. 19, 2024
(86) PCT No.: PCT/US2024/025317

§ 371 Date: Oct. 21, 2025

Related U.S. Application Data
(60) Provisional application No. 63/461,053, filed on Apr. 21, 2023.

(51) Int. Cl. E05B 29/00

(52) U.S. Cl. CPC E05B 29/0013; E05B 29/0026; E05B 29/006; E05B 29/0066

(57) ABSTRACT

A mechanically keyed lock assembly with isolated validation to prevent non-destructive defeat of the mechanically keyed lock assembly, including a plurality of locking modules having a key engaging element, a spacer, a key validating element configured to establish a fixed rotational relationship between one of the key engaging element and the key validating element or the spacer and the key validating element, and a validation bar configured to achieve validation in the key validating elements only when isolated from the key engaging elements.

### CROSS REFERENCE TO RELATED APPLICATION

This patent application claims the benefit of U.S. Provisional Application No. 63/461,053, titled Mechanically Keyed Locks with Isolated Validation, filed Apr. 21, 2023, the entire contents of which is expressly incorporated by reference herein.

### TECHNICAL FIELD

The present disclosure is directed mechanically keyed locks with isolated validation.

### BACKGROUND

Mechanically keyed locks utilize elements, such as key engaging elements and key validating elements, that interact with a coded key to directly or indirectly interact with a validation mechanism. Typically, the key engaging elements and key validating elements are defined by a single component that both engages with the key and interact with the validation mechanism. Such locks may be vulnerable to various non-destructive defeats. One vulnerability is the ability to manipulate the interaction of the key validating elements and the validation mechanism at the point of validation usually through manipulation of the key engaging elements, shimming, or other various methods to defeat the lock.

### SUMMARY OF THE DISCLOSURE

The present disclosure describes mechanically keyed locks with isolated validation. The isolated validation is achieved by separating the key validating elements from key engaging elements such that when the key engaging elements are able to manipulate the key validating elements, the key validating elements are prevented from interacting with the key validating mechanism. When the validation process begins, the key validating elements are rigidly kept in coded position as well as rigidly isolated from manipulation from the key engaging elements or other manipulation.

In some examples, the disclosure describes a mechanically keyed lock assembly including: a housing having a proximal end and distal end defining an actuation axis; a locking module assembly captured between proximal cap and distal cap, including plurality of locking modules arranged along the actuation axis and actuated by mechanical key; a carrier seated on the locking module assembly, defining and translatable along a carrier axis; an alignment bar for selective engagement with the locking module assembly; a validation bar seated within axial slot defined by the carrier, also arranged for selective engagement with the locking module assembly; where each locking module includes a key engaging element, a key validating element, and a spacer aligned along actuation axis, the key engaging element engaged and rotationally manipulated about the actuation axis by the mechanical key, the key validating element defining alignment notch configured to receive the validation bar, the spacer including asymmetric passage that slidingly receives cross-section of mechanical key; where the validation bar and the locking module assembly includes at least one isolation feature configured to decoupled the validation bar from key engaging element prior to validation.

In some examples, the disclosure describes a method for isolating validation of a mechanically keyed lock assembly, that includes the steps of: (a) providing a mechanically keyed lock assembly including a housing, a locking module assembly captured between proximal and distal caps, and a carrier seated on the locking module assembly; (b) translating the carrier along a carrier axis to selectively engage with a validation bar disposed within an axial slot defined by the carrier; (c) rotating the locking module assembly about an actuation axis in response to insertion of a mechanical key into the housing, where the rotation causes the alignment bar to become coupled to the key engaging element of the locking modules and dislodges the validation bar from its initial position; (d) continuing the rotation of the carrier and locking module assembly through a transition angle, causing the ramped lateral edge of the clearance slot to force the validation bar radially inward toward the actuation axis, where the features of the validation bar are seated within the alignment notches of the key validating element; (e) rotating the locking module assembly until the mechanically keyed lock assembly is in a fully unlocked configuration.

In some examples, the disclosure describes a mechanically keyed lock assembly including: a housing; a locking module assembly captured between proximal and distal caps of the housing, the locking module assembly including a plurality of locking modules arranged along an actuation axis; a carrier seated on the locking module assembly, the carrier defining and being translatable along a carrier axis; an alignment bar arranged for selective engagement with the locking module assembly; a validation bar seated within an axial slot defined by the carrier, the validation bar also being arranged for selective engagement with the locking module assembly, where the validation bar defines a isolation feature configured to physically isolate the validation bar from at least a portion of the mocking module assembly prior to validation; and mating structures configured to establish a fixed rotational relationship between a key engaging element and a key validating element of the locking module assembly or the key validating element and a spacer of the locking module assembly while enabling axial translation therebetween, where the spacer retains the rotational position of the key validating element when translated off of the key engaging element during validation.

In some examples, the disclosure describes a lock assembly having mechanically isolated validation, including: a locking module assembly extending longitudinally along an actuation axis and including a plurality of locking modules, each locking module including: a key engaging element configured to interact the key; a spacer; and a key validating element configured to establish a fixed rotational relationship between one of the key engaging element prior to validation and the spacer during validation, where, when the validation process begins, the key validating element is rigidly kept in a coded position and rigidly isolated from manipulation from the key engaging elements.

### BRIEF DESCRIPTION OF THE DRAWINGS

FIGS. 1 and 2 are perspective views of a mechanically keyed lock assembly with a housing depicted in phantom.

FIGS. 3 and 4 are exploded perspective views of elements of a locking module of the mechanically keyed lock assembly of FIG. 1.

FIGS. 5 and 6 are perspective views of a carrier of the mechanically keyed lock assembly of FIG. 1 with a key validating element disposed therein.

FIGS. 7 and 8 are perspective views of a housing of the mechanically keyed lock assembly of FIG. 1.

FIG. 9 is a sectional view of the housing of FIG. 7.

FIG. 10 is a sectional view at a distal face of a flange portion of the housing of FIG. 7.

FIGS. 11 and 12 are perspective views of a distal end of the housing of FIG. 7.

FIG. 13 is a perspective, partial assembly view of the mechanically keyed lock assembly of FIG. 1 when a mechanical key is initially inserted therein.

FIG. 14 is a sectional view of the fully assembled mechanically keyed lock assembly at plane XIV of FIG. 13.

FIG. 15 is a perspective, partial assembly view of the mechanically keyed lock assembly of FIG. 1 at a point of validation.

FIG. 16 is a sectional view of the fully assembled mechanically keyed lock assembly at plane XVI of FIG. 15.

FIG. 17 is a perspective, partial assembly view of the mechanically keyed lock assembly of FIG. 1 in an unlocked configuration.

FIG. 18 is a sectional view of the fully assembled mechanically keyed lock assembly at plane XVIII of FIG. 17.

FIG. 19 is a conceptual diagram illustrating an example mechanical key for use with the keyed lock assemblies described herein.

FIGS. 20 and 21 are conceptual diagrams illustrating perspective views of an example lock assembly.

FIGS. 22 and 23 are conceptual diagrams illustrating exploded perspective views of a locking module of the locking assembly of FIGS. 20 and 21.

FIGS. 24 and 25 are conceptual diagrams illustrating perspective view of an example carrier of the locking module of FIGS. 20 and 21.

FIGS. 26 through 28 are conceptual diagrams illustrating elevated side views of various positions of an example validation bar prior to validation, during validation, and at the point of validation of the locking module of FIGS. 20 and 21.

FIG. 29 is a flow diagram illustrating an example technique for manufacturing the locking assemblies described herein.

### DETAILED DESCRIPTION OF THE FIGURES

The mechanically keyed lock assemblies described in the present disclosure provide novel security mechanisms to enhance protection against unauthorized access. The locking module assembly, which houses multiple locking modules, is actuated by a mechanical key that interacts with various components to enable the lock to be unlocked or locked. The key engaging element and key validating element of each locking module are configured to work together in a specific manner, providing added security against manipulation.

The key engaging element, which is engaged and manipulated by the mechanical key, includes an alignment pin that interacts with a groove on the key to align the elements for unlocking. The key validating element, which is translatable along a carrier axis, is configured to receive the validation bar during the unlocking process. The spacer, which isolates the key validating element from the key engaging element at the point of validation, prevents manipulation of the locking module at this valuable juncture, adding an extra layer of security.

The carrier, which is seated on the locking module assembly and includes a cam protrusion with angled cam surfaces that interact with the housing, contributes to the functioning of the lock. The cam protrusion causes the carrier to be translated axially along its axis as the locking module assembly is rotated, which enables the key validating element to engage with the spacer and ultimately unlock the mechanism.

The housing, which includes an alignment bar slot and a clearance slot, captures and aligns the alignment bar during the unlocking process. The clearance slot, which includes recessed surfaces and ramped lateral edges, provides additional security by forcing the validation bar radially inward towards the actuation axis as rotation continues until the lock is fully unlocked.

The described lock assemblies can be made from various materials such as stainless steel, other steel alloys, titanium, brass, or other material to improve its performance and durability. The housing, carrier, and locking module assembly can also incorporate additional features like tamper-evident rings or complex shapes to enhance security. Different configurations of the locking module assembly and spacer can be configured to provide added security benefits, such as more complex shapes that make it harder to manipulate the locking module assembly or asymmetric passages in the spacer that further complicate the insertion of the mechanical key.

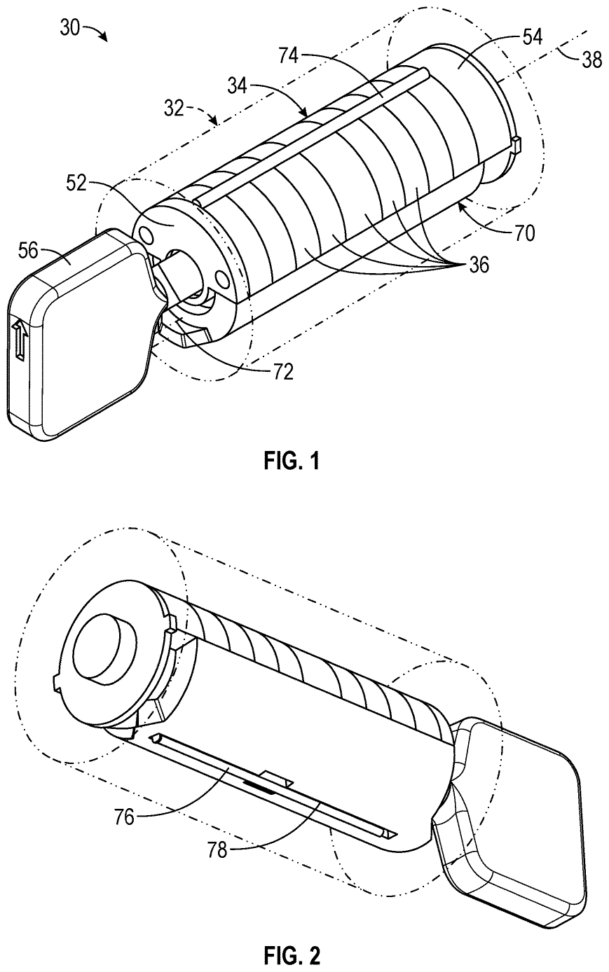

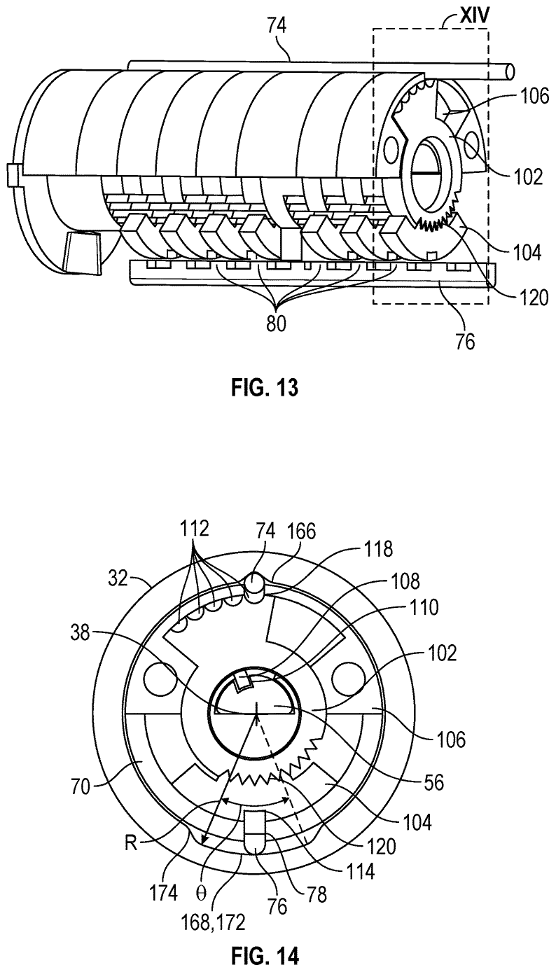

Referring to FIGS. 1 and 2, a mechanically keyed lock assembly 30 is depicted according to an embodiment of the disclosure. The mechanically keyed lock assembly 30 includes a housing 32 that houses a locking module assembly 34 that includes a plurality of locking modules 36 that define and are arranged along an actuation axis 38. The locking module assembly 34 is captured between a proximal cap 52 and a distal cap 54 and is actuated by a mechanical key 56. A carrier 70 is seated on the locking module assembly 34, the carrier 70 defining and being translatable along a carrier axis 72. An alignment bar 74 is arranged for selective engagement with the locking module assembly 34. A validation bar 76 is seated within an axial slot 78 (also referred to as a validation aperture) defined by the carrier 70, the validation bar 76 also being arranged for selective engagement with the locking module assembly 34. The validation bar 76 may define a plurality of features 80 (also referred to as validation features) (FIG. 13).

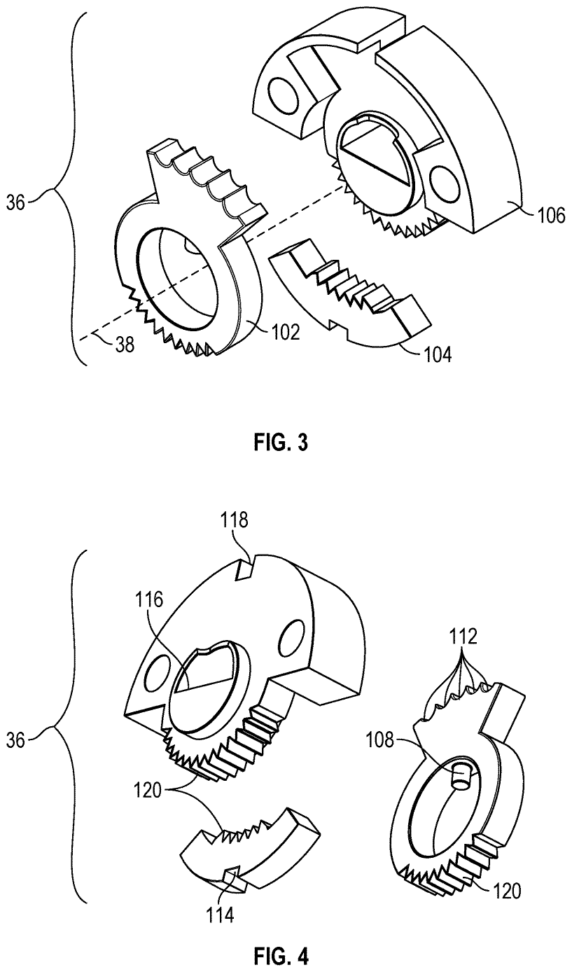

Referring to FIGS. 3 and 4, components of a given locking module 36 are depicted according to an embodiment of the disclosure. Each locking module 36 includes a key engaging element 102, a key validating element 104, and a spacer 106. In assembled form, the key engaging element 102 and the spacer 106 are aligned along the actuation axis 38, with the key validating element 104 being translatable along the carrier axis 72 for selective engagement with either the key engaging element 102 or the spacer 106.

The key engaging element 102 engages and is manipulated about the actuation axis 38 by the mechanical key 56. The key engaging element 102 may include an alignment pin 108 that extends radially inward to interact with, for example, a groove 110 (FIG. 14) on the mechanical key 56 that is configured to align the key engaging element 102 and key validating element 104 for unlocking. The key engaging element 102 also includes structure configured to receive the alignment bar 74, for example a plurality of scallops 112. The key validating element 104 defines an alignment notch 114 configured to receive the validation bar 76. The spacer 106 includes an asymmetric passage 116 that complements and slidingly receives a cross-section of the mechanical key 56. The spacer 106 may also define an alignment notch 118 configured to receive the alignment bar 74.

The key engaging element 102 and spacer 106 include mating structure 120 that interface with the key validating element 104, for example arcuately arranged teeth (depicted). The mating structures 120 establish a fixed rotational relationship between the key engaging element 102 and key validating element 104 or spacer 106 and key validating element 104 while enabling axial translation therebetween. That is, the spacer 106 is configured to rotationally fix the key validating element 104 relative to a position established by the key engaging element 102 at the point of validation. Hence, the spacer 106 retains the rotational position of the key validating element 104 when it is translated off of the key engaging element 102 during validation. In this way, the spacer 106 isolates the key validating element 104 from the key engaging element 102 at the point of validation.

Unlike traditional disc locks with locking modules (i.e., discs) having a key validating element and a key engaging element that define a unitary components or are otherwise fixed, the isolation of key engaging element 102 and key validating element 104 enabled by spacer 106 prevents manipulation of locking module 36 at the point of validation thereby providing additional security.

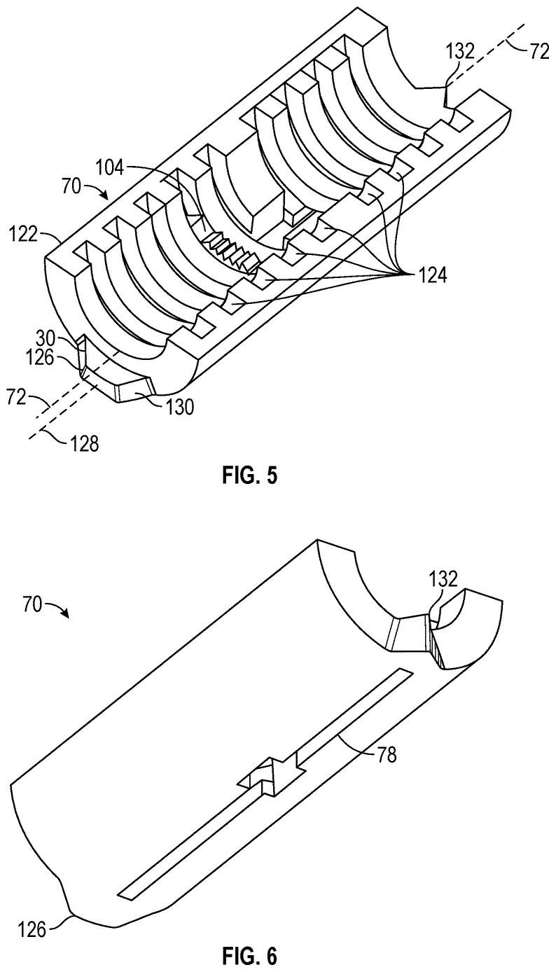

Referring to FIGS. 5 and 6, the carrier 70 is depicted in greater detail according to an embodiment of the disclosure. The carrier 70 includes a body portion 122 that defines a plurality of slots 124 arranged orthogonal to the carrier axis 72 and configured to accept the key validating element 104 of the locking modules 36 of the locking module assembly 34. The carrier 70 includes a cam protrusion 126 that defines a protrusion axis 128 that extends parallel to the carrier axis 72. The cam protrusion 126 includes at least one cam surface 130 (two depicted) that is angled relative to the protrusion axis 128, extending away from the body portion 122 and toward the protrusion axis 128. In some embodiments, the carrier 70 includes a guide protrusion 132 that projects from the body portion 122. The cam protrusion 126 and guide protrusion 132 may be located at opposed ends of the body portion 122 (depicted).

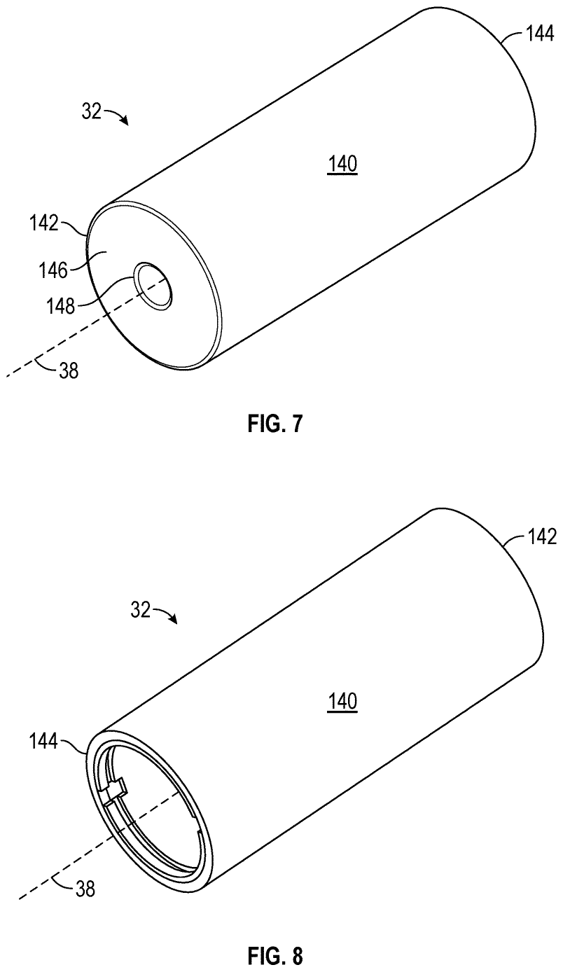

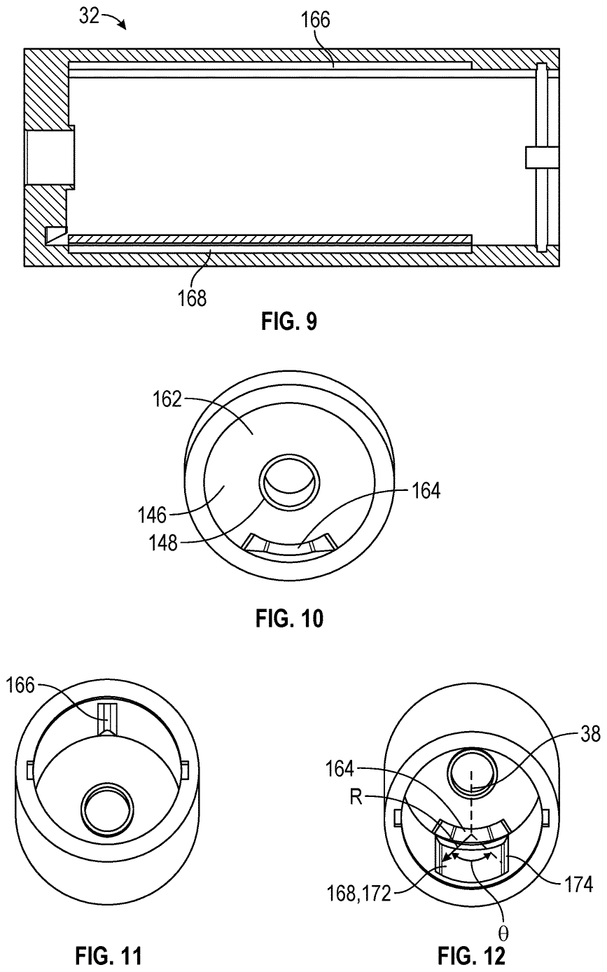

Referring to FIGS. 7 through 12, the housing 32 is depicted in more detail according to an embodiment of the disclosure. The housing 32 includes a body portion 140 having a proximal end 142 and a distal end 144. In some embodiments, the proximal end 142 includes a flange portion 146 that defines an access port 148 for passage of the mechanical key 56. A distal face 162 of the flange portion 146 may define a pocket 164 configured to complement and slidingly accept the cam protrusion 126. In some embodiments, the body portion 140 of the housing 32 defines an alignment bar slot 166 (also referred to as a locking bar slot) and a clearance slot 168 (also referred to as a validation bar slot). The alignment bar slot 166 is configured to receive and capture the alignment bar 74. The clearance slot 168 includes a recessed surface 172 that defines a radius R relative to the actuation axis 38 about a transition angle θ. The clearance slot 168 may include ramped lateral edges 174 that transition from the recessed surface 172.

Referring to FIGS. 13 through 18, operation of the mechanically keyed lock assembly 30 is depicted according to an embodiment of the disclosure. The housing 32, mechanical key 56, carrier 70, and some of the proximal elements of the locking module assembly 34 are removed from the perspective views of FIGS. 13, 15, and 17 for clarity, but are included in the counterpart cross-sectional views of FIGS. 14, 16, and 18.

When the mechanically keyed lock assembly 30 is in a locked configuration with no key inserted, the key engaging element 102 and key validating element 104 for each of the locking modules 36 are coupled, for example, by mating of the arcuately arranged teeth 120. The key validating element 104 of a given locking module 36 is coupled to the counterpart key engaging element 102 is in a predetermined configuration relative to each other. The rotational orientation of the key engaging element 102 may be random about the actuation axis 38. Also in the locked configuration, the validation bar 76 (disposed within the axial slot 78 of the carrier 70) is decoupled from the key validating element 104 and in contact with the recesses surface 172 of the clearance slot 168. The alignment bar 74 is seated within the alignment bar slot 166 with the cross section of the alignment bar 74 extending partially into the alignment notches 118 of the spacer 106, the alignment bar 74 being decoupled from the key engagement elements 102 of the locking modules 36.

Upon insertion, the mechanical key 56 engages the alignment pins 108 to rotationally orient the key engaging element 102 and key validating element 104 of the locking modules 36 about the actuation axis 38 such that, when the mechanical key 56 is fully inserted, the alignment notches 114 of the key validating element 104 are aligned adjacent to the validation bar 76 (FIGS. 13 and 14).

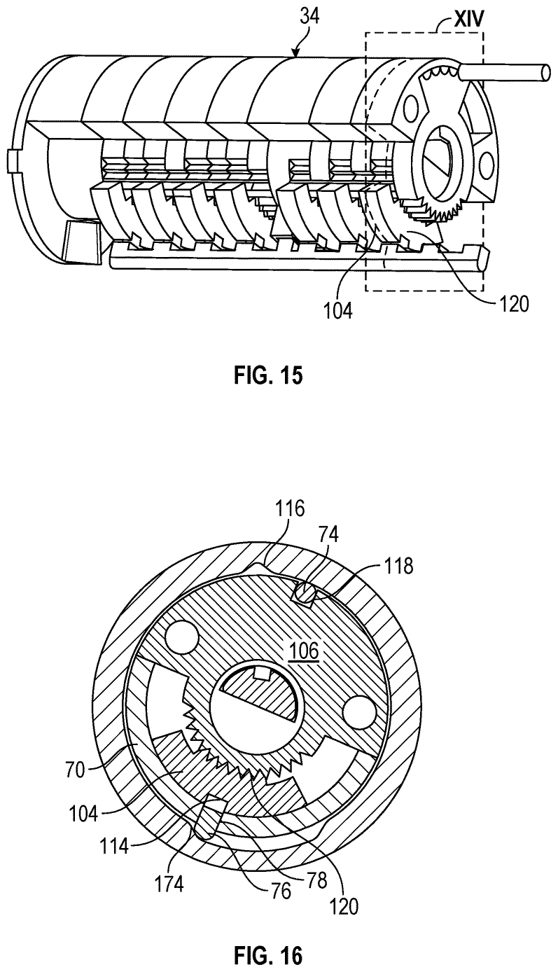

The mechanical key 56 is then rotated, which rotates the locking module assembly 34 and carrier 70 about the actuation axis 38. Initially, the rotation of the locking module assembly 34 causes an interaction between the spacer 106 and the alignment bar 74 that dislodges the alignment bar 74 from the alignment bar slot 166 and into the alignment notches 118 of the spacer 106 (FIGS. 15 and 16). This action also causes the alignment bar 74 to become coupled to the key engaging element 102 of the locking modules 36, for example at a respective one of the plurality of scallops 112 of each key engaging element 102.

After alignment bar 74 is coupled with key engaging element 102, continued rotation of the carrier 70 causes the angled cam surface 130 of the cam protrusion 126 to slide against the pocket 164 of the stationary flange portion 146 of the housing 32, thereby causing the carrier 70 to be translated axially along the carrier axis 72 as the locking module assembly 34 is rotated through the transition angle θ. The axial translation of the carrier 70 causes the key validating element 104, which are coupled to the carrier 70 (for example by registration within the plurality of slots 124 of the carrier 70) to slide out of engagement with the key validating elements 104 and into engagement with the spacer 106 (FIGS. 15 and 16).

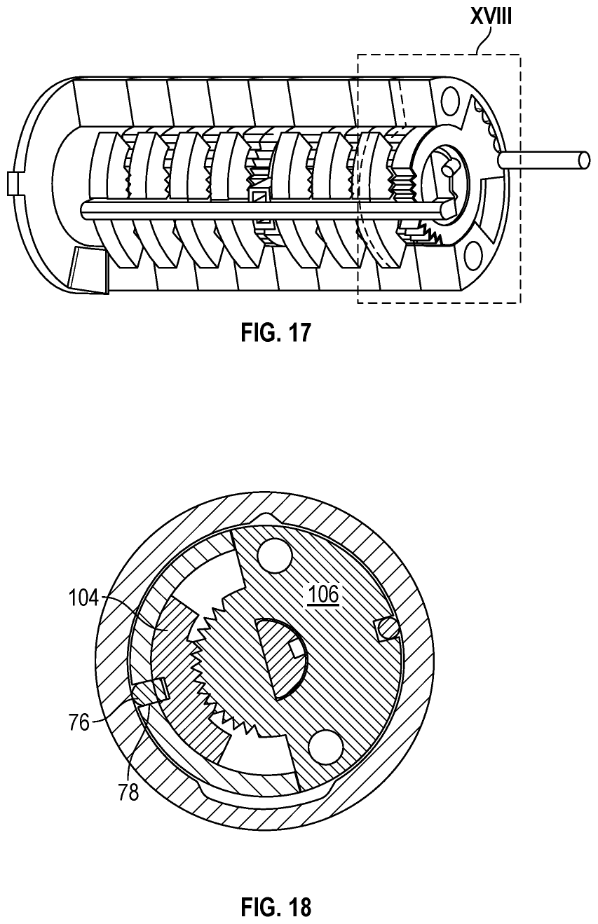

As rotation of the locking module assembly 34 and carrier 70 continues through and beyond the transition angle θ, the ramped lateral edge 174 of the clearance slot 168 forces the validation bar 76 radially inward, toward the actuation axis 38, so that the features 80 of the validation bar 76 are seated within the alignment notches 114 of the key validating element 104 (FIGS. 17 and 18). Rotation continues until the mechanically keyed lock assembly 30 is in a fully unlocked configuration.

Functionally, the key engagement elements 102 and key validating element 104, when coupled together in the locked configuration, are free to rotate about the actuation axis 38 as a unit, for example within the limits provided by the spacer 106 to which they are respectively coupled. Because the key validating element 104 are mechanically isolated from the validation bar 76, manipulation of the key engagement elements 102 and key validating element 104 when coupled together provides no information regarding the rotational orientation required to for unlocking. Also, the carrier 70 prevents the key validating element 104 from being manipulated individually onto the spacer 106. That is, only when all the key validating element 104 are properly aligned can the validation bar 76 be translated radially inward to enable continued rotation of the locking module assembly 34.

The coupling of the alignment bar 74 to the key engaging elements 102 maintains the orientation of the key engaging element 102 relative to the key validating element 104 of the locking module assembly 34 after the transfer of the key validating element 104 onto the spacer 106. The coupling of the validation bar 76 to the key validating element 104 is possible only if all the alignment notches 114 of the key validating element 104 are aligned with the validation bar 76.

The key engaging element may be nested or otherwise inlaid into a portion of the spacer to prevent shimming between the key engaging element and the spacer.

Once transitioned axially, the validating elements are isolated from the key engaging elements. Therefore, manipulation of the key engaging elements cannot be utilized to determine the point of validation between the key validating element and the spacer. Moreover, vibration of the key validating element does not provide vibration feedback through the key engaging element.

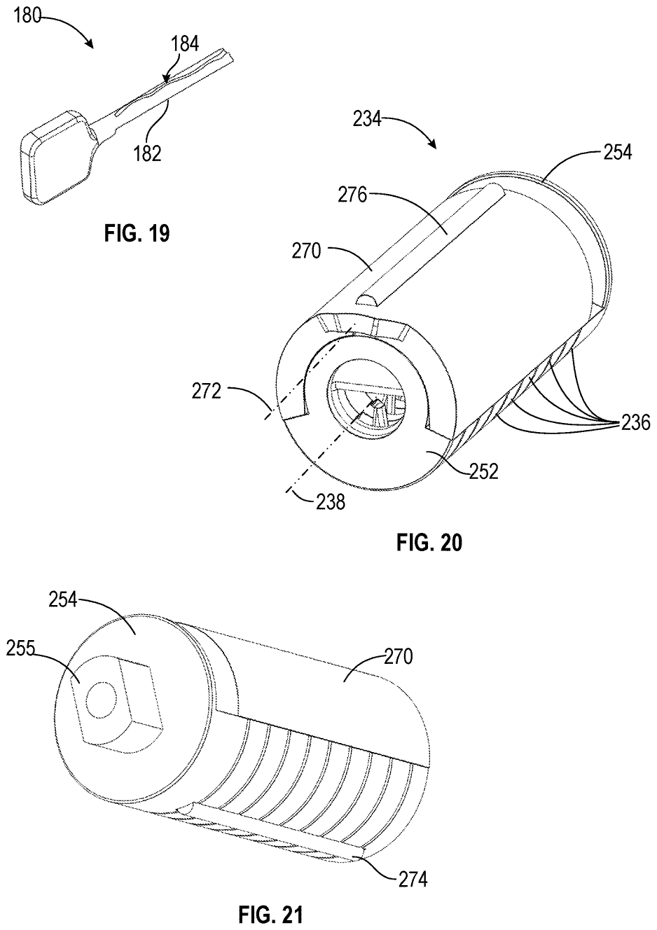

FIG. 19 is a conceptual diagram illustrating an example mechanical key 180 for use with keyed lock assembly 30. Mechanical key 180 may include a keyed section 182 defining a groove 184. Groove 184 is configured to engage the alignment pin (e.g., alignment pin 108) of each key engaging element (e.g., key engaging element 102) as key 180 is inserted into keyed lock assembly 30. For example, an alignment pin of a proximal-most key engaging element may rotate along the actuation axis as the alignment pin traverses groove 184 until key 180 is fully seated and the key engaging element assumes a rotational position that enables validation. Each distally subsequent alignment pin engages groove 184 and is rotated as the respective alignment pins traverse groove 184 until the key is fully seated and the respective key engaging element assumes a rotational position that enables validation.

In some examples, a cross-sectional profile of key 180 (e.g., taken perpendicular to an axis extending longitudinally along keyed section 182) may include a semi-circular shape, such as a half circle. In other examples, a cross-sectional profile of key 180 may be other geometry or irregular shape. Complex or irregular shape may enhance security by making components of the lock assembly more difficult to access.

Although described included a mechanical key having groove 184, in other examples, key 180 may be a magnetic key. For example, key 180 may include a plurality of magnetic elements or other magnetic alignment features disposed at selected points along the axial and circumferential plane of keyed section 182. As one example, the plurality of magnetic elements may be spaced along a path similar to that of groove 184. Each of the plurality of magnetic elements may be configured to magnetically interact (e.g., attract) a respective alignment pin such that when fully seated each respective key engaging element may assume a rotational orientation that enables validation. Moreover, each of the alignment pins may be replaced with a corresponding magnetic element such that no physical features protrude inward from key engaging element. Such configuration may future deter attempts of destructive or nondestructive defeat of lock assembly 30.

FIGS. 20 and 21 are conceptual diagrams illustrating perspective views of an example lock assembly 230. Lock assembly 230 may be the same as or substantially similar to lock assembly 30 described above in reference to FIGS. 1 through 18, except for the differences described herein. For example, lock assembly 230 may include a housing (not shown) that houses a lock module assembly 234 having a plurality of locking modules 236 extending along an actuation axis 238. The locking module assembly 234 is captured between a proximal cap 252 and a distal cap 254 and is actuated by a key (e.g., key 180). In some examples, distal cap 254 may include a coupling protrusion 255 configured to mechanically engage a locking mechanism, such as a deadbolt or the like. A carrier 270 is seated on the locking module assembly 234, the carrier 270 defining and being translatable along a carrier axis 272. An alignment bar 274 is arranged for selective engagement with the locking module assembly 234. A validation bar 276 is seated within an axial slot 278 (also referred to as a validation aperture) defined by the carrier 270, the validation bar 276 also being arranged for selective engagement with the locking module assembly 234.

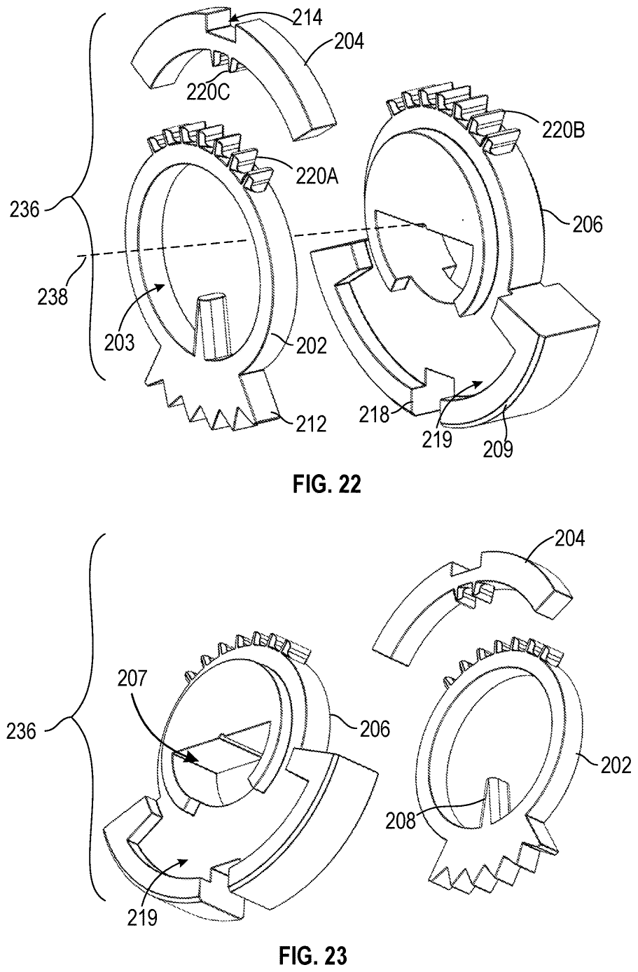

FIGS. 22 and 23 are conceptual diagrams illustrating exploded perspective views of a locking module 236 of the locking assembly 230 of FIGS. 20 and 21. As illustrated in FIGS. 22 and 23, each lock module 236 of the locking module assembly 234 extends longitudinally along actuation axis 238. Each lock module 236 includes a key engaging element 202, a key validating element 204, and a spacer 206.

Key engaging element 202 defines a first aperture 203 configured to receive therethrough a key (e.g., key 180). In some examples, the shape of first aperture 203 may correspond to a cross section of the key. For example, first aperture 203 may define an asymmetric passage that complements and slidingly receives a cross-section of the key. Key engaging element 202 includes an alignment feature 208 configured to interact the key, a first mating structure 220A, and a first alignment bar receiving structure 212. Alignment features 208 may include an alignment pin as illustrated or, in some examples, a magnetic feature, such as a permanent magnetic, which may be integrally formed with or otherwise embedded in key engaging element 202. First mating structure 220A may include a plurality of gear teeth or similar mating structures. First alignment bar receiving structures 212 may include a plurality of scallops, gear teeth, or other arcuately arranged structures having protrusions and valleys between adjacent protrusions that may receive therein at least a portion of alignment bar 274.

Key validating element 204 includes a third mating structure 220C and a validation bar receiving structure 214. Third mating structure 220C is configured to interface with each of first mating structure 220A and second mating structure 220B. For example, third mating structure 220C may include a plurality of gear teeth or similar mating structures corresponding to the first and second mating structures 220A and 220B. In this way, third mating structure 220C is configured to establish a fixed rotational relationship between one of key engaging element 202 and key validating element 204 (e.g., prior to validation) or spacer 206 and key validating element 204 (e.g., at the point of validation). Validation bar receiving structure 214 may include a rectilinear or arcuate recess defined by key validating element 204 size to receive therein at least a portion of validating bar at least at the point of validation.

Spacer 206 defining a second aperture 207 configured to receive therethrough the key. In some examples, the shape of second aperture 207 may correspond to a cross section of the key. For example, second aperture 207 may define an asymmetric passage that complements and slidingly receives a cross-section of the key. Spacer 206 also includes second mating structure 220B and a second alignment bar receiving structure 218. Second alignment bar receiving structure 218 may include a rectilinear or arcuate recess defined by spacer 206 size to receive therein at least a portion of alignment bar prior to validation. Second mating structure 220B may be the same as or substantially similar to first mating structure 220A. In this way, first and second mating structures 220A and 220B may be configured to receive key validating element 204 in longitudinal translatable engagement. That is, just prior to validation, locking assembly 230 may be configured such that key validating element 204 longitudinally translates from key engaging element 202 to spacer 206 thereby isolating key engaging element 202 from key validating element 204 at the point of validation.

In some examples, spacer 206 may include a tapered side edge 209. Tapered side edge 209 may enable laser welding of adjacent spacer 206 during manufacture of locking assembly 230. By laser welding adjacent spacers 206, locking assembly 230 may define an integral unit and prevent shimming between adjacent spacers 206 as a means of nondestructive defeat.

To further complicate nondestructive defeat attempts, such as shimming, in some examples, the distal facing surface, proximal facing surface, or both of spacer 206 may define a recess 219 configured to receive therein at least a portion, such as at least one half of a thickness of each adjacent key engaging element 202. Recess 219 increases the difficulty in passing a shim through the keyhole and between adjacent key engaging elements 202 and spacers 206. Moreover, recesses 219 may facilitate welding of adjacent spacers 206.

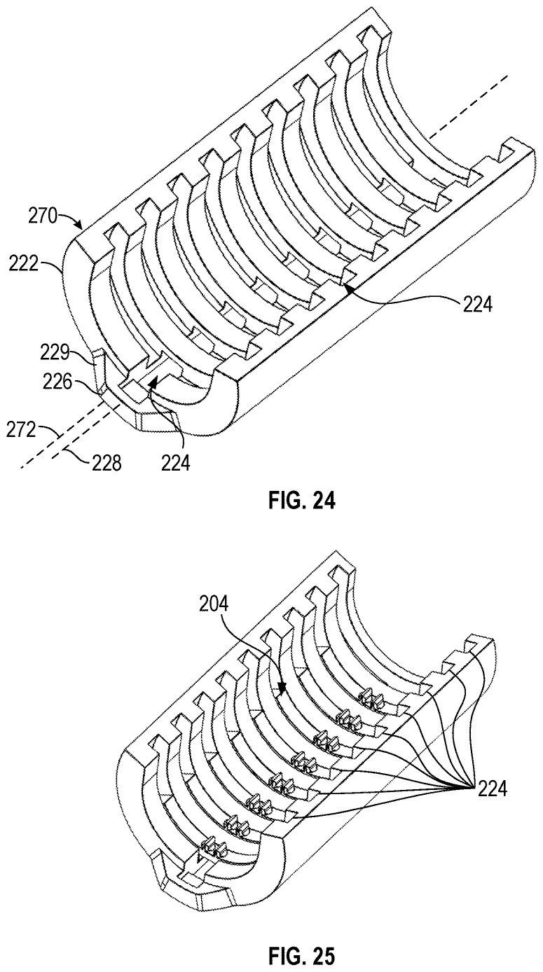

FIGS. 24 and 25 are conceptual diagrams illustrating perspective view of an example carrier 270 of locking assembly 230 of FIGS. 20 and 21. As illustrated in FIGS. 24 and 25, carrier 270 extends along carries axis 272, which extends parallel to actuation axis 238. Carrier 270 is longitudinally translatable along a carrier axis 272. Carrier 270 includes a body portion 222 extending along carrier axis 272. Body portion 222 defines a plurality of slots 224 extending circumferentially orthogonal to carrier axis 272. Each plurality of slots 224 is configured to receive therein at least a portion of the key validating element 204 of each locking module 236. Each of key validating elements 204 is slidingly engaged in a circumferential direction (i.e., an arc) with a respective slot of plurality of slots 224 and fixed in the axial direction relative to carrier 270. In this way, key validating elements 204 may travel in the circumferential direction when a key (e.g., key 180) is inserted thereby causing rotational movement of key engaging elements 202 and key validating elements 204 travel with carrier 270 during validation whereby carrier 270 and each key validating elements 204 travels axial along carrier axis 272 to engage each key validating element 204 with a respective spacer 206 thereby physically isolating the key engaging elements 202 during validation.

Carrier 270 also defines validation aperture 278 (also referred to as an axial slot) extending longitudinally parallel to carrier axis 272. Validation aperture 278 is configured to receive therein at least a portion of validation bar 276. For example, validation bar 276 may travel in validation aperture 278 in a radial direction during validation, i.e., whereby validation bar 278 is seated into each validation bar receiving structure 214 of each respective key validating element 204.

Carrier 270 also includes cam protrusion 226 extending from body portion 222 in the axial direction. Cam protrusion 226 defines a protrusion axis 228 extending parallel to the carrier axis 272. Cam protrusion 226 includes at least one cam surface 229 that is angled relative to protrusion axis 228. For example, cam surface 229 may extend axially away from body portion 222 and toward protrusion axis 228 at an angle within a range from approximately 5-degrees to approximately 80-degrees, such as within a range from approximately 20-degrees to approximately 60-degrees. Cam protrusion 226 may extend from body portion 222 any suitable amount, such as a distance equal or greater than a thickness of key engaging elements 202. In this way, cam protrusion 226 may axially translate key validating elements 204 from engagement with key engaging elements 202 to engagement with spacers 206 during validation.

In some examples, carrier 270 may include a guide protrusion (e.g., guide protrusion 132) extending from the body portion along carrier axis 272, where cam protrusion 226 and the guide protrusion may be located at opposed ends of body portion 222. The guide portion may be configured to aid in axial or circumferential positioning of carrier 270 during validation.

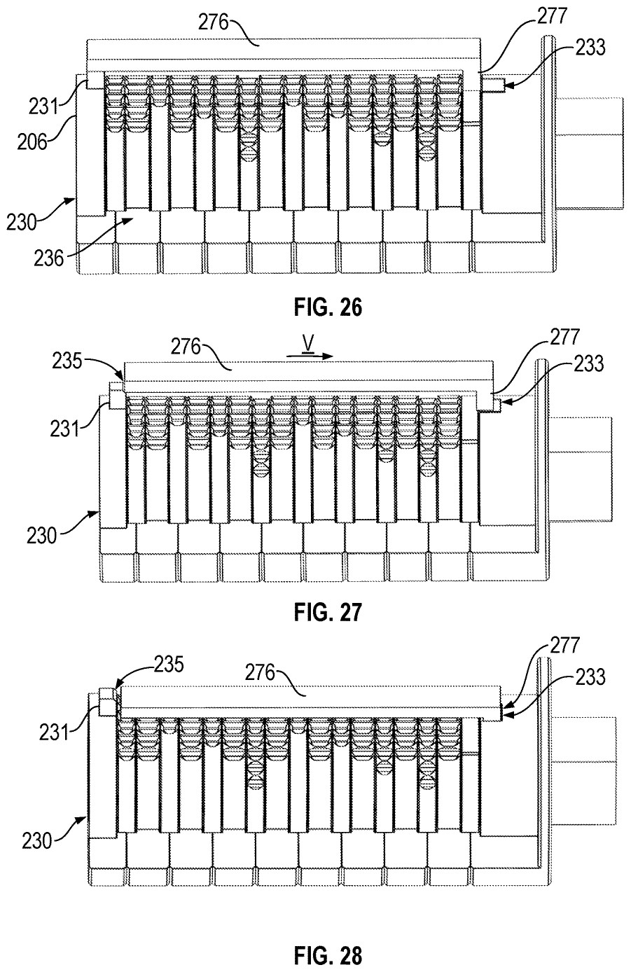

FIGS. 26 through 28 are conceptual diagrams illustrating elevated side views of various positions of validation bar 276 prior to validation, during validation, and at the point of validation of locking assembly 230 of FIGS. 20 and 21. As discussed above, validation bar 276 is disposed in validation aperture 278 and extending across each key validation element 204. In some examples, validation bar 276 may define validation features, e.g., slots or apertures, configured to selectively engage the locking module assembly. For example, such validation features may be configured to receive therein at least a portion of key engaging elements 202, spacers 206, or both. In other examples, validation bar 276 may include a solid component, such as a solid metal rod devoid of validation features and include an isolation protrusion 277.

Validation bar 276 interacts with locking module assembly 234 to provide a positive separation, e.g., a physical isolation, between validation bar 276 and locking module 236 prior to validation. In some examples, validation bar 276 defines a first isolation feature including a radial inward protrusion configured to be received within a validation bar receiving structure of at least one first spacer. At least one second spacer defines a second isolation feature including a radial outward protrusion configured to support at least a portion of the validating bar. The first isolation feature and the second isolation feature are configured to, when not in a validation position, mechanically isolate the validation bar from each key validating element.

For example, locking module assembly 234 includes a proximal spacer 206 having a validation bar isolation feature 231 and a distal validation bar isolation protrusion receiver 233. The validation bar isolation feature 231 is configured to retain validation bar 276 in a radially outward position relative to at least a portion of locking module assembly 234, e.g., key validating elements 204, prior to validation. In some examples, a sloped distal surface 235 of validation bar isolation feature 231 may be sloped radially inward. During validation, as validation bar 276 translates with carrier 270 along carrier axis 272, as indicated by arrow V, at least a proximal portion of validation bar 276 may translate across sloped distal surface 235. At the point of validation, isolation protrusion 277 may be received within distal validation bar isolation protrusion receiver 233. Once validation is achieved, validation bar 276, together with locking module assembly 234 and alignment bar 274 may be rotated about actuation axis.

Similar to locking assembly 30, locking assembly 230 includes a housing defining a cylindrical cavity to receive locking module assembly 234, carrier 270, validation bar 276, and alignment bar 274. The housing defines an alignment bar slot and a clearance slot (e.g., validation bar slot), each extending longitudinally parallel to actuation axis 238.

The alignment bar slot and the clearance slot are configured to receive therein and retain the respective alignment bar 274 and validation bar 276 and prevent rotation of the locking module assembly 234 unless the validation bar 276 is in a validated position. For example, when in a first rotational state prior to the validation position, alignment bar 274 is configured to rotationally fix each key engaging element 202. When in a validated position, validation bar 276 is positioned within the validation bar receiving structure 214 of each key validation element 204.

The clearance slot may include a recessed surface having ramped lateral edges. Comparatively, the clearance slot may be wider (e.g., define a recess having a greater circumferential distance) than the alignment bar slot. During operation, this difference in slot width may necessitate that the alignment bar engages and rationally fixes key engaging element 202 before validation bar 276 would contact the ramped surface of the clearance slot.

In some examples, the alignment bar slot is offset from validation aperture 278 by about 180-degrees. In other examples, the offset may be within a range from about 10-degrees to about 170-degrees.

The relative position of alignment bar slot and clearance slot may be selected to enable rekeying of locking assembly 230. For example, after validation, when rotated to a position where alignment bar 274 may move into the clearance slot, the key validation elements 204 are engaged with the spacers 206 and the key engaging elements are disengaged from alignment bar 274 and able to freely rotate. Hence, the key may be removed in this position and a second, different with a different groove pattern may be inserted. The key engaging elements 202 will rotate to confirm to the new key code defined by the key groove. Then, the locking assembly may be rotated to reengage the alignment bar with the key engaging elements 202, thereby fixing the new code.

In some examples, locking assembly 230 may include a proximal cap fixed to a first, proximal end of the housing and defining an access port configured to receive therethrough the key and a pocket to receive cam protrusion 226. Rotation of the locking module assembly 234 causes cam protrusion 226 to traverse out of the pocket and translate carrier 270 along the carrier axis 272.

In some examples, locking assembly 230 may include a distal cap fixed to a second, opposing (distal) end of the housing. The distal cap may define a pocket configured to complement and slidingly accept at least a portion of the cam guide.

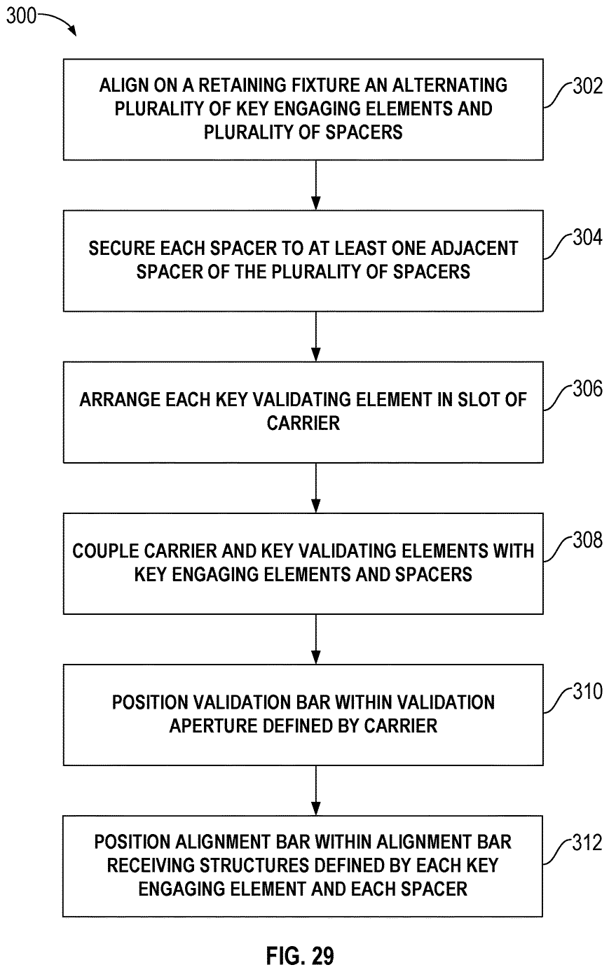

FIG. 29 is a flow diagram illustrating an example technique 300 for manufacturing the locking assemblies described herein. Although technique 300 is described in reference to locking assemblies 30 and 230, the technique may be used to manufacture other locking assemblies. Additionally, other techniques may be used to manufacture locking assemblies 30 and 230.

Technique 300 includes aligning on a retaining fixture extending longitudinally along an actuation axis 238 an alternating plurality of key engaging elements 202 and plurality of spacers 206 (302). In some examples, the retaining fixture may include an elongate tool or a key having a keyed section 182 and a groove 184. In some examples, groove 184 of the retaining fixture may be substantially straight. For example, a substantially straight groove 184 may align each key engaging element 202 in the same rotational orientation. In some examples, the alternating plurality of key engaging elements 202 and plurality of spacers 206 may be aligned on the retaining fixture using a robotic arm or the like.

In some examples, prior to aligning the plurality of key engaging elements 202 and plurality of spacers 206 may be aligned on the retaining fixture, the technique may include forming the plurality of key engaging elements 202 and plurality of spacers 206. Key engaging elements 202 and spacer 206 (as well as other components of locking assembly 230 including but not limited to key validating elements 204, alignment bar 274, validating bar 276, and carrier 270) may be formed using additive manufacturing techniques, such as, e.g., fluid bed laser sintering, substrative manufacturing techniques, such as, e.g., machining, or other metallurgical technique, such as, e.g., forging or casting.

Technique 300 also includes securing each spacer to at least one adjacent spacer of the plurality of spacers (304). In some examples, securing may include welding, for example, laser welding or laser spot welding. In other examples, securing may include securing by mechanical fasteners, screws, pegs, adhesives, or the like. Tapered side edge 209 of spacers 206 may enable welding at an interface defined by two adjacent spacers 206 without requiring machining or removal of weld material for appropriate clearance when positioned within the housing. This may enable automated welding of adjacent spacers 206, automated assembly of locking module assembly 234 with a housing, or both.

Technique 300 also includes arranging each of a plurality of key validating element 204 in a respective slot of a plurality of slots 224 defined by body portion 222 of carrier 270 extending along carrier axis 272 (306). In some examples, the technique may include placing by a robot or the like, key validating element 204 into slots 224. In some examples, a sacrificial material, such as a wax or an adhesive which can be later flashed off using a thermal treatment or removed with a solvent, may be used to temporarily secure key validating element 204 in slots 224 to enable automated assembly. Alternatively, technique 300 may include positioning, e.g., by a robot or the like, key validating element 204 on to respective key engaging elements 202 or spacers 206, and positioning carrier 270 to capture each key validating element 204 in a respective slot 224.

Technique 300 may include coupling, in longitudinally translatable engagement, carrier 270 and the plurality of key validating elements 204 with the plurality of key engaging elements 202 and plurality of spacers 206 to define a locking module assembly 234 and carrier 270 (308). In some examples, the coupling may include positioning, by a robot or the like, key validating elements 204 on key engaging elements 202 and spacers 206 to define locking module assembly 234 and carrier 270 on the locking module assembly 234.

Technique 300 also includes positioning validation bar 276 within validation aperture 278 defined by carrier 270 (310). In some examples, each a validation bar receiving structure 214 defined by each key validating element 204 of the plurality of key validating elements 204 is positioned to receive validation bar 276 therein. In this way, validation bar 276 is assembled with locking module assembly 234 in the validated position. This may enable simplified assembly because the locking module assembly 234 and validation bar 276 may be inserted into a housing and then rekeyed after assembly without requiring tracking or knowledge of the key code provided by the key engaging elements 202.

Technique 300 also includes positioning alignment bar 274 within a first alignment bar receiving structure 212 defined by each key engaging element 202 of the plurality of key engaging elements 202 and a second alignment bar receiving structure 218 defined by each spacer 206 of the plurality of spacers 206 (312). In this way, alignment bar 274 is assembled with locking module assembly 234 in the validated position and key engaging elements 202 locked in position by alignment bar 274. This may enable simplified assembly because the locking module assembly 234 and alignment bar 274 may be inserted into a housing and then rekeyed after assembly without requiring tracking or knowledge of the key code provided by the key engaging elements 202.

In some examples, technique 300 may further include inserting, e.g., by robot or the like, into a housing (e.g., housing 32) the coupled locking module assembly 234 and carrier 270, validation bar 276, and alignment bar 274. The housing may define a cylindrical cavity having an alignment bar slot (e.g., alignment bar slot 166) and a clearance slot (e.g., clearance slot 168), each extending longitudinally parallel to the actuation axis 238.

In some examples, technique 300 may further include rekeying the locking assembly 230. For example, the technique may include receiving within the clearance slot the respective alignment bar 274 in a rekey configuration, inserting a key into locking assembly 230 to encode locking assembly 230 to a code of the key, and rotating locking assembly 230 to a locked configuration to set the code of the key.

In some examples, the technique may include securing the rekeyed locking assembly 230, for example, by packaging the rekeyed locking assembly in a packaging. The packaging may include a plastic packaging, a cardboard packaging, or a combination thereof.

The locking assemblies described herein may be provided in a kit. The kit may include the one or more described locking assemblies and instructions. The instructions may include instructions for installing locking assembly 230. Additionally, or alternatively, the instructions may include instructions for rekeying locking assembly. The instructions for rekeying locking assembly 230 may include inserting a key having a current key code for locking assembly 230, rotating with the key locking assembly through the point of validation and to a point where alignment bar 274 is received with in the clearance slot of the housing.

The following clauses illustrate example subject matter described herein.
Clause 1. A mechanically keyed lock assembly comprising: a housing having a proximal end and distal end defining an actuation axis; a locking module assembly captured between proximal cap and distal cap, comprising plurality of locking modules arranged along the actuation axis and actuated by mechanical key; a carrier seated on the locking module assembly, defining and translatable along a carrier axis; an alignment bar for selective engagement with the locking module assembly; a validation bar seated within axial slot defined by the carrier, also arranged for selective engagement with the locking module assembly; wherein each locking module comprises a key engaging element, a key validating element, and a spacer aligned along actuation axis, the key engaging element engaged and rotationally manipulated about the actuation axis by the mechanical key, the key validating element defining alignment notch configured to receive the validation bar, the spacer comprising asymmetric passage that slidingly receives cross-section of mechanical key; wherein the validation bar and the locking module assembly comprise at least one isolation feature configured to decoupled the validation bar from key engaging element prior to validation.
Clause 2. The mechanically keyed lock assembly of clause 1, wherein the key engaging element, the key validating element, and the spacer comprise respective mating structures establishing fixed rotational relationship between the key engaging element and the key validating element or key validating element and the spacer while enabling axial translation of the key validating element between the key engaging element and the spacer.
Clause 3. The mechanically keyed lock assembly of clause 2, wherein isolation of key engaging element and key validating element enabled by spacer prevents manipulation of locking module at validation point.
Clause 4. The mechanically keyed lock assembly of any one of clauses 1 through 3, wherein the validation bar further comprises validation features comprising protrusions, indentations, or other structures that enhance security or customization of lock assembly.
Clause 5. The mechanically keyed lock assembly of any one of clauses 1 through 4, wherein the carrier comprises a cam protrusion configured to cause the axial translation of the key validating element during validation.
Clause 6. The mechanically keyed lock assembly of any one of clauses 1 through 5, wherein locking module assembly is rotated through transition angle of between approximately 20-degrees and approximately 90-degrees before validation bar is translated radially inward to enable continued rotation of locking module assembly.
Clause 7. The mechanically keyed lock assembly of any one of clauses 1 through 6, wherein the key engaging element, the key validating element, and the spacer comprise respective teeth or other arcuately arranged structures that establish fixed rotational relationship between elements while enabling axial translation therebetween.
Clause 8. A method for isolating validation of a mechanically keyed lock assembly, comprising the steps of: (a) providing a mechanically keyed lock assembly comprising a housing, a locking module assembly captured between proximal and distal caps, and a carrier seated on the locking module assembly; (b) translating the carrier along a carrier axis to selectively engage with a validation bar disposed within an axial slot defined by the carrier; (c) rotating the locking module assembly about an actuation axis in response to insertion of a mechanical key into the housing, wherein the rotation causes the alignment bar to become coupled to the key engaging element of the locking modules and dislodges the validation bar from its initial position; (d) continuing the rotation of the carrier and locking module assembly through a transition angle, causing the ramped lateral edge of the clearance slot to force the validation bar radially inward toward the actuation axis, wherein the features of the validation bar are seated within the alignment notches of the key validating element; (e) rotating the locking module assembly until the mechanically keyed lock assembly is in a fully unlocked configuration.
Clause 9. The method for isolating validation of a mechanically keyed lock assembly of claim 8, further comprising providing a validation feature on the validation bar to physically isolate the validation bar from the key engaging element prior to validation.
Clause 10. The method for isolating validation of a mechanically keyed lock assembly of claim 8 or 9, wherein the alignment bar is decoupled from the key engaging elements before being coupled with the spacer.
Clause 11. The method for isolating validation of a mechanically keyed lock assembly of any one of claims 8 through 10, wherein the alignment bar is configured to rotationally fix the key engaging element relative to a position established by the key as the carrier axially translates the key validating element from the kay engaging elements to the spacers prior to the point of validation.
Clause 12. A mechanically keyed lock assembly comprising: a housing; a locking module assembly captured between proximal and distal caps of the housing, the locking module assembly comprising a plurality of locking modules arranged along an actuation axis; a carrier seated on the locking module assembly, the carrier defining and being translatable along a carrier axis; an alignment bar arranged for selective engagement with the locking module assembly; a validation bar seated within an axial slot defined by the carrier, the validation bar also being arranged for selective engagement with the locking module assembly, wherein the validation bar defines a isolation feature configured to physically isolate the validation bar from at least a portion of the mocking module assembly prior to validation; and mating structures configured to establish a fixed rotational relationship between a key engaging element and a key validating element of the locking module assembly or the key validating element and a spacer of the locking module assembly while enabling axial translation therebetween, wherein the spacer retains the rotational position of the key validating element when translated off of the key engaging element during validation.
Clause 13. The mechanically keyed lock assembly of clause 12, wherein the key engaging element and spacer are mechanically isolated from each other.
Clause 14. The mechanically keyed lock assembly of clause 12 or 13, wherein the alignment bar and spacer are configured to rotationally fix the key validating element relative to a position established by the key engaging element at the point of validation.
Clause 15. The mechanically keyed lock assembly of any one of clauses 12 through 14, wherein the mating structures comprise arcuately arranged teeth.
Clause 16. The mechanically keyed lock assembly of any one of clauses 12 through 15, wherein the carrier comprises a cam protrusion defining a protrusion axis that extends parallel to the carrier axis, and at least one cam surface that is angled relative to the protrusion axis, extending away from the body portion and toward the protrusion axis.
Clause 17. The mechanically keyed lock assembly of any one of clauses 12 through 16, wherein the housing defines an alignment bar slot and a clearance slot, the alignment bar slot configured to receive and capture the alignment bar, and the clearance slot comprising a recessed surface that defines a radius R relative to the actuation axis about a transition angle.
Clause 18. The mechanically keyed lock assembly of clause 17, wherein the alignment bar is configured to be received in the clearance slot when the locking module assembly is in a rekey position.
Clause 19. The mechanically keyed lock assembly clause 18, wherein the validation bar is configured to remain in a validated position when in the rekey position.
Clause 20. The mechanically keyed lock assembly clause 18, wherein the locking module assembly comprises a rotational stop configured to prevent accidental rotation of the locking module assembly into the rekey position.
Clause 21. A lock assembly having mechanically isolated validation, comprising: a locking module assembly extending longitudinally along an actuation axis and comprising a plurality of locking modules, each locking module comprising: a key engaging element defining a first aperture configured to receive therethrough a key, comprising: an alignment feature configured to interact the key; a first mating structure; and a first alignment bar receiving structure; a spacer defining a second aperture configured to receive therethrough the key, comprising: a second mating structure; and a second alignment bar receiving structure; and a key validating element comprising: a third mating structure configured to interface with each of the first mating structure and the second mating structure, wherein the third mating structures is configured to establish a fixed rotational relationship between one of the key engaging element and the key validating element or the spacer and the key validating element; and a validation bar receiving structure, a carrier longitudinally translatable along a carrier axis extending parallel to the actuation axis, comprising: a body portion extending along the carrier axis, defining: a plurality of slots extending circumferentially orthogonal to the carrier axis and configured to receive therein at least a portion of the key validating element of each locking module, and a validation aperture extending longitudinally parallel to the carrier axis; and a cam protrusion extending from the body portion, defining a protrusion axis extending parallel to the carrier axis, comprising at least one cam surface that is angled relative to the protrusion axis, extending away from the body portion and toward the protrusion axis; a validation bar disposed in the validation aperture and extending across each key validation element; an alignment bar configured to be retained in the alignment bar slot; and a housing defining a cylindrical cavity to receive the locking module assembly, the carrier, the validation bar, and the alignment bar, wherein the housing defines an alignment bar slot and a clearance slot, each extending longitudinally parallel to the actuation axis, wherein the alignment bar slot and the clearance slot are configured to receive therein the respective alignment bar and validation bar and prevent rotation of the locking module assembly unless the validation bar is in a validated position.
Clause 22. A mechanically keyed lock assembly, comprising: a locking module assembly extending longitudinally along an actuation axis and comprising a plurality of locking modules, each locking module comprising: a key engaging element comprising: an alignment pin configured to interact with a groove defined by a mechanical key; an alignment bar receiving feature configured to engage with an alignment bar a plurality of scallops configured to receive at least a portion of the alignment bar and an alignment notch configured to receive at least a portion of the validation bar; a key validating element; and a spacer defining an asymmetric passage that complements and slidingly receives a cross-section of the mechanical key, wherein the spacer further defines an alignment notch configured to receive at least a portion of the alignment bar; wherein the key engaging element and the spacer comprise respective mating structures to interface with key validating element, wherein the respective mating structures comprise arcuately arranged teeth, wherein the respective mating structures establish a fixed rotational relationship between one of the key engaging element and the key validating element or the spacer and the key validating element, a carrier seated on at least a portion of the locking module assembly, wherein the carrier defines and is translatable along a carrier axis, wherein the carrier defines a validation aperture extending longitudinally parallel to the carrier axis, wherein the carrier defines a plurality of slots extending circumferentially orthogonal to the carrier axis and configured to receive therein at least a portion of the key validating element of each locking module, wherein the carrier comprises a cam protrusion defining a protrusion axis extending parallel to the carrier axis, wherein the cam protrusion includes at least one cam surface that is angled relative to the protrusion axis, extending away from the body portion and toward the protrusion axis, wherein the carrier comprises a guide protrusion that projects from the body portion, wherein the cam protrusion and the guide protrusion may be located at opposed ends of the body portion; a validation bar disposed in the validation aperture, wherein the validation bar defines a plurality of validation features configured to selectively engage the locking module assembly; a alignment bar configured to be retained in the alignment bar slot a housing defining a cylindrical cavity to receive the locking module assembly and the carrier; wherein the housing defines an alignment bar slot extending longitudinally parallel to the carrier axis, and wherein the alignment bar slot is offset from the validation aperture by about 180-degrees, wherein housing comprises a recessed surface having ramped lateral edges extending longitudinally parallel to the carrier axis and defining a clearance slot configured to receive therein at least a portion of the validation bar; and a proximal cap fixed to a first end of the housing and a distal cap fixed to a second, opposing end of the housing, wherein the proximal cap defines an access port configured to receive therethrough the mechanical key, wherein distal cap defines a pocket configured to complement and slidingly accept at least a portion of the cam protrusion.
Clause 23. A lock assembly having mechanically isolated validation, comprising: a locking module assembly extending longitudinally along an actuation axis and comprising a plurality of locking modules, each locking module comprising: a key engaging element configured to interact the key; a spacer; and a key validating element configured to establish a fixed rotational relationship between one of the key engaging element prior to validation and the spacer during validation, wherein, when the validation process begins, the key validating element is rigidly kept in a coded position and rigidly isolated from manipulation from the key engaging elements.

1. A lock assembly having mechanically isolated validation, comprising:
a locking module assembly extending longitudinally along an actuation axis and comprising a plurality of locking modules, each locking module comprising:
a key engaging element defining a first aperture configured to receive therethrough a key, comprising an alignment feature configured to interact the key and a first mating structure;
a spacer defining a second aperture configured to receive therethrough the key, comprising a second mating structure; and
a key validating element comprising a third mating structure configured to interface with each of the first mating structure and the second mating structure, wherein the third mating structures is configured to establish a fixed rotational relationship between one of the key engaging element and the key validating element or the spacer and the key validating element, and a validation bar receiving structure;
a carrier longitudinally translatable along a carrier axis extending parallel to the actuation axis, comprising a body portion extending along the carrier axis, defining a plurality of slots extending circumferentially orthogonal to the carrier axis and configured to receive therein at least a portion of the key validating element of each locking module, and defining a validation aperture extending longitudinally parallel to the carrier axis, and a cam protrusion extending from the body portion, defining a protrusion axis extending parallel to the carrier axis, comprising at least one cam surface that is angled relative to the protrusion axis, extending away from the body portion and toward the protrusion axis;
a validation bar disposed in the validation aperture and extending across each key validation element; and
a housing defining a cylindrical cavity to receive the locking module assembly, the carrier, and the validation bar, wherein the housing defines a clearance slot extending longitudinally parallel to the actuation axis, wherein the clearance slot is configured to receive therein the validation bar and prevent rotation of the locking module assembly unless the validation bar is in a validated position.

2. The lock assembly of claim 1, further comprising an alignment bar configured to be retained in the alignment bar slot, wherein, when in a first rotational state prior to the validation position, the alignment bar is configured to rotationally fix each key engaging element, and wherein, when in a validated position, the validation bar is positioned within the validation bar receiving structure of each key validation element.

3. The lock assembly of claim 1, wherein the alignment bar slot is offset from the validation aperture by about 180-degrees, wherein the housing comprises a recessed surface having ramped lateral edges defining a clearance slot.

4. The lock assembly of claim 1, wherein the alignment feature comprises an alignment pin configured to interact with a groove defined by the mechanical key, and wherein the alignment pin extends radially into at least a portion of the aperture.

5. The lock assembly of claim 1, wherein the alignment feature comprises a magnetic alignment feature configured to interact with a corresponding magnetic feature embedded in the key.

6. The lock assembly of claim 1, wherein at least one of the first aperture and the second aperture define an asymmetric passage that complements and slidingly receives a cross-section of the key.

7. The lock assembly of claim 1, wherein the first alignment bar receiving structure of the key engaging element defines a plurality of scallops aligned along a circumferential arc, each scallop configured to receive at least a portion of the alignment bar.

8. The lock assembly of claim 1, wherein the second alignment bar receiving structure comprises an alignment bar notch configured to receive at least a portion of the alignment bar.

9. The lock assembly of claim 1, wherein the first mating structure and the second mating structure comprise a plurality of arcuately arranged teeth, and wherein the third mating structure comprises one or more corresponding arcuately arranged teeth.

10. The lock assembly of claim 1, wherein the key validating element defines an arcuate structure corresponding to a first arcuate surface defined by the first mating structure of the key engaging element and the second mating structure of the spacer.

11. The lock assembly of claim 1, wherein the carrier further comprises a guide protrusion extending from the body portion along the carrier axis, and wherein the cam protrusion and the guide protrusion may be located at opposed ends of the body portion.

12. The lock assembly of claim 1, wherein the validation bar defines a plurality of validation features configured to selectively engage the locking module assembly.

13. The lock assembly of claim 1, wherein the validation bar comprises a solid metal rod.

14. The lock assembly of claim 1, wherein the validation bar defines a first isolation feature comprising a radial inward protrusion configured to be received within the validation bar receiving structure of at least one spacer, wherein at least one spacer defines a second isolation feature comprising a radial outward protrusion configured to support at least a portion of the validating bar, wherein the first isolation feature and the second isolation feature are configured to, when not in a validation position, mechanically isolate the validation bar from each key validating element.

15. The lock assembly of claim 1, further comprising a proximal cap fixed to a first end of the housing and defining an access port configured to receive therethrough the key and a pocket to receive the cam protrusion, wherein rotation of the locking module causes the cam protrusion to traverse out of the pocket and translate the carrier along the carrier axis.

16. The lock assembly of claim 1, further comprising a distal cap fixed to a second, opposing end of the housing, wherein the distal cap defines a pocket configured to complement and slidingly accept at least a portion of the cam protrusion.

17. A method of assembling a lock assembly, wherein the method comprises:
aligning on a retaining fixture extending longitudinally along an actuation axis an alternating plurality of key engaging elements and plurality of spacers;
welding each spacer to at least one adjacent spacer of the plurality of spacers;
arranging each of a plurality of key validating element in a respective slot of a plurality of slots defined by a body portion of a carrier extending along a carrier axis;
coupling, in longitudinally translatable engagement, the carrier and the plurality of key validating elements with the plurality of key engaging elements and plurality of spacers to define a lock assembly and a carrier, wherein the carrier axis extends parallel to the actuation axis;
positioning a validation bar within a validation aperture defined by the carrier and extending along the carrier axis, wherein each a validation bar receiving structure defined by each key validating element of the plurality of key validating elements is positioned to receive the validation bar therein; and
positioning an alignment bar within a first alignment bar receiving structure defined by each key engaging element of the plurality of key engaging elements and a second alignment bar receiving structure defined by each spacer of the plurality of spacers.

18. The method of claim 17, wherein the method further comprises inserting into a housing coupled locking assembly and the carrier, the validation bar, and the alignment bar, and wherein the housing defines a cylindrical cavity having an alignment bar slot and a clearance slot, each extending longitudinally parallel to the actuation axis.

19. The method of claim 18, wherein the clearance slot receives therein the respective alignment bar in a rekey configuration, and wherein the method further comprises:
inserting a key into the locking assembly to encode the locking assembly to a code of the key; and
rotating the locking assembly to a locked configuration to set the code of the key.

20. The method of claim 17, wherein:
the body portion of the carrier extends along the carrier axis and defines the plurality of slots extending circumferentially orthogonal to the carrier axis, and wherein the carrier further defines the validation aperture extending longitudinally parallel to the carrier axis and a cam protrusion extending from the body portion, defining a protrusion axis extending parallel to the carrier axis, comprising at least one cam surface that is angled relative to the protrusion axis, extending away from the body portion and toward the protrusion axis;
each key engaging element of the plurality of key engaging elements comprises an alignment feature configured to interact the key, a first mating structure, and a first alignment bar receiving structure;
each spacer of the plurality of spacers comprises a second mating structure and a second alignment bar receiving structure; and
each key validating element of the plurality of key validating elements comprises a third mating structure configured to interface with each of the first mating structure and the second mating structure, wherein the third mating structures is configured to establish a fixed rotational relationship between one of the key engaging element and the key validating element or the spacer and the key validating element.
